(19) United States
(12) Patent Application Publication
(10) Pub. No.: US 2010/0088748 A1
(43) Pub. Date: Apr. 8, 2010

(54) Secure peer group network and method thereof by locking a mac address to an entity at physical layer

(76) Inventor: Yoel Gluck, San Francisco, CA (US)

Correspondence Address: YOEL GLUCK;C/O Nif/T, LLC, 19160 BAINTER AVE, Los Gatos, CA, 95030, US

(21) Appl. No.: 12/585,586

(22) Filed: Sep. 18, 2009

Related U.S. Application Data
(60) Provisional application No. 61/195,095, filed on Oct. 3, 2008.

(51) Int. Cl. H04L 9/00

(52) U.S. Cl. 726/3

(57) ABSTRACT

A system and method of locking media access control (MAC) address of each entity to the entity's identity for formation of a secure peer group is disclosed. The identity of each entity includes at least the public key from the public-private key pair from public key infrastructure (PKI) and the entities' MAC address. Using the unique identifying features a security server links and locks the MAC address of the entity to its identity so that no other entity can identify itself as the owner of that MAC address to the secure server. A group of such entities and secure server with locked MAC addresses form a qualified and verifiable secure peer group enabled to establish a secure LAN.

### CROSS REFERENCE TO RELATED APPLICATION

This application claims the benefit of U.S. Provisional Patent Application No. 61/195,095 filed on Oct. 3, 2008, and is further related to a co-pending provisional patent application 61/195,098 filed on Oct. 3, 2008.

### TECHNICAL FIELD

The invention relates to improving the security of networks and specifically to providing means for providing security within the data link layer to eliminate vulnerability to attacks.

### BACKGROUND OF THE INVENTION

Network security has become a major concern due to the rapid growth of use of the Internet. Though there are several ways and programs to provide security in the application, transport, or network layers of a network, there are still too many points of vulnerability in the network. One area of vulnerability is the data link layer, also known as Layer 2, where security has not been adequately addressed as of yet. Layer 2 enables interoperability and interconnectivity of networks. Any real vulnerability in the Layer 2, which enables attacks, is not easily detected by the upper layers today.

In the past, local area networks (LANs) have been considered safe and hence little effort at securing the LAN was made. A typical LAN comprises one or more domains which are data link layer domains called Layer 2 domains. The LAN is connected to the internet by routers. Within each LAN, traffic is forwarded based on MAC addresses. LANs typically use switches to connect between entities within a LAN. Switches are also used to link multiple Layer 2 domains within a LAN. The routers route traffic based on internet protocol (IP) addresses or other network layer addresses for transport through the Internet cloud. Within the Internet cloud the connectivity is dynamic and routing takes place based on available resources and paths. In the LAN the traffic is routed based on the MAC address of individual entities.

Typically Ethernet devices have unique media access control (MAC) addresses assigned by a central authority to ensure that no two devices have the same MAC address. Because source MAC address information is inserted into Ethernet frames during communication by the Ethernet devices, the source address in an Ethernet frame had been considered accurate and difficult to fake. Since in theory Ethernet MAC addresses are unique, at least on the same Layer 2 network and potentially globally, any entity on a Layer 2 network can address any other entity on the network by using the MAC address assigned to the entity being addressed.

Layer 2 forwarding tables are used to connect to and send data between entities in the LAN. The Layer 2 forwarding table is normally created from header information received in Ethernet frames. This is done by storing the MAC address obtained from an Ethernet frame in a Layer 2 forwarding table along with information identifying the port on which the frame including the header was received. Frames directed to the stored MAC address will be output via the port indicated in the Layer 2 forwarding table. Since the information in the Layer 2 forwarding table is obtained from Ethernet Frame headers it was considered to be reliable.

Recently attacks on LANs have become a matter of concern. A typical attack on a LAN occurs where an attacker already has access to one entity within the LAN. The attacker then attacks the network traffic by presenting itself as the owner of different MAC addresses in the LAN to divert traffic to itself. The attacker can then establish access to sniff and/or modify network traffic between other entities within the LAN.

It would hence be advantageous to confirm the identity of an entity in a LAN at the Layer 2 level such that no other entity in or out of the LAN is able to mimic being that entity. It would be further advantageous to be able to recognize and identify any entity that is part of a LAN and confirm the entities MAC address. It would be furthermore advantageous if the solution would enable to create a verifiable peer group of members of a LAN.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a typical and exemplary LAN with the secure server.

FIG. 2 is a typical flow chart of configuring and making the secure server the first member of the peer group.

FIG. 3 is a typical flow chart of locking the identity of an entity in a LAN to its MAC address and making the entity a member of the peer group.

### DETAILED DESCRIPTION OF THE INVENTION

A system and method of locking media access control (MAC) address of each entity to the entity's identity for formation of a secure peer group is disclosed. The identity of each entity includes at least the public key from the public-private key pair from public key infrastructure (PKI) and the entities' MAC address. Using the unique identifying features a security server links and locks the MAC address of the entity to its identity so that no other entity can identify itself as the owner of that MAC address to the secure server. A group of such entities and secure server with locked MAC addresses form a qualified and verifiable secure peer group enabled to establish a secure LAN.

The MAC address of each entity is considered to be unique in a global setting. Therefore, the disclosed invention shows the locking of this unique MAC address of each entity to the entity's identity, thereby forming a secure peer group of such locked entities. The identity of each entity includes at least the public key of the entity from the public-private key pair and the entities' MAC address. Using these and any other available unique identifying features, a security server, that is also a member of the peer group, links and locks the MAC address of each member entity to its own identity. This information is stored in a database by the secure server. This locking of MAC address to an identity of an entity prevents any other entity from presenting and identifying itself to the server as the owner of that locked MAC address. A group of entities with locked

MAC addresses, forming a qualified and verifiable peer group is enabled to establish a secure network. Though the current invention is focused towards the LAN network it is not meant to be limiting. With suitable modifications the invention disclosed may be used in a LAN, a wide area network (WAN), a metro network or an enterprise. The locking of a MAC address of the entity to its identity is hence an essential step to secure a LAN providing protection against attacks.

The invention disclosed herein below can be therefore used as part of a secure network solution, and more specifically for securing a LAN by uniquely identifying and pre-qualifying entities for inclusion into a qualified secure peer group (SPG). Securing of the LAN is performed with identified MAC addresses being locked to their corresponding identities. This secure peer group is provided with the necessary information and capability to enable establishment of a fully integrated security perimeter and internal connectivity between all the entities that are qualified members of the LAN group. The prospective members of the SPG use the public key infrastructure (PKI) that binds public keys with respective private keys, for initiation of authentication between the peers in the SPG.

The method is implemented at various nodes of a network, typically as a first step, to prevent attacks on a LAN, including attacks using Layer 2 to Layer 4. During initial configuration of the LAN, a security client is downloaded into each entity that wishes or designated to be part of the secure LAN. This security client enables each entity to generate its own public-private key pair using PKI. The public key of the entity is used as part of the identity of the entity. A secure server, also a member of the secure LAN, having its own identity including public key and certificate is enabled to act as administrative server for the LAN. This secure server is provided with the MAC address and identity of each entity requesting to be a part of the LAN, including its public key. The secure server locks the MAC address of the entity to the entity's identity and stores the information in a data base. The secure server depending on the group and security policies of the LAN accepts or rejects the request of each entity. If accepted, the secure server prepares a unique identification (ID) for the entity. This identity is stored in the database with the locked MAC address and public key. The ID is also sent to the entity accepting it as part of the LAN.

The entities in a LAN, together with their respective identity that is locked to their respective MAC addresses, form a secure peer group. Locking the MAC address to the identity of the entities prevents any other entities that may have access to the LAN, from using the MAC address that belongs to a secured entity to authenticate itself to the secure server as part of the SPG. Knowledge of the identity of individual entities linked to their MAC addresses reduces the capability of any attacking entity from initiating and sustaining attacks within the LAN network. Preferably, for improved security, all entities on the LAN shall belong to a secure peer group on the LAN. It is possible for a plurality of SPGs to be part of a single LAN and conversely a single SPG to span a plurality of LANs.

An entity is not limited to be a member of one secure peer group. The entity can be a member of any number of secure peer groups, where the entity has legitimate access according to the policies set up for that group. Hence an entity that is a member of a home network is able to be a member of a LAN network at the work place as well. The configuration and authentication for the entity has to be done independently for each secure peer group.

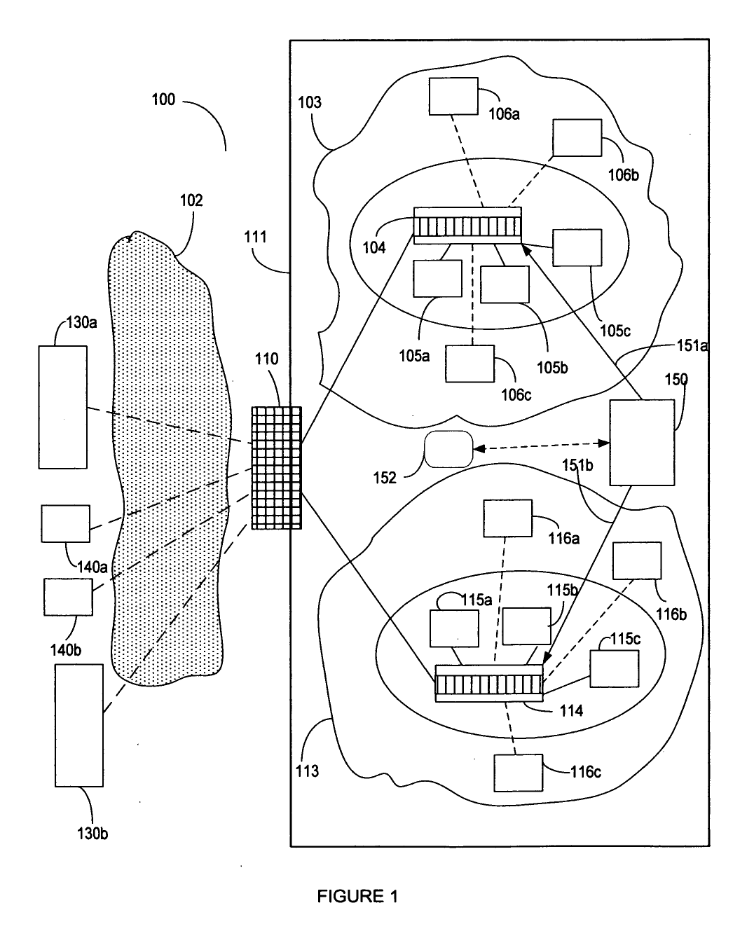

FIG. 1 shows a typical, exemplary and non-limiting network 100 that includes a local area network. In order to configure the LAN 111, a secure administrative server, also referred to herein as a secure server, 150 is provided with the security and group policies for a peer group. The entities 105a to 105c are connected by wire and entities 106a to 106c are connected by wireless to switch 104. Entities 115a to 115c are connected by wire and the entities 116a to 116c are connected by wireless to switch 114. The two switches 104 and 114 are part of the LAN 111. The secure server 150 with a storage database 152 is used as an administrative and a local dynamic host configuration protocol (DHCP) server. The LAN 111 is connected to the internet by the router 110. The entities 130a, 130b, 140a and 140b are connected to the LAN via the router 110 from outside the perimeter of the LAN 111.

Once enabled, the secure server 150, typically downloads from a secure location or has manually input into it a security client and additional configuration information. In another embodiment of the disclosed invention the secure server 150 comes preconfigured. The preconfigured security server has preinstalled security and group policies for a peer group, security client and additional configuration information. The secure server then generates a pair of public and private keys using PKI. In an exemplary instance the secure server 150 also requests, and receives, a certificate from a CA (not shown). The secure server 150 then locks its own MAC address to its own ID and stores the information in its database 152. It hence becomes the first qualified and verifiable entity in the peer group.

In an exemplary and non-limiting installation the secure server 150 is now enabled to upload the security client into any entity that wants to be added to a secure peer group. This step in configuration typically is a download to the entity based on request from the entity. In an alternate embodiment of the invention this can be a manual operation of providing the security client and configuration information to each qualified entity, for example to entity 130a. The entity 130a is now enabled to generate a public and private key pair using PKI. The entity 130a then requests inclusion in the SPG sending its identity and MAC address to the secure server 150.

In a preferred embodiment the requesting entity 130a sends its identity information comprising its public key and its MAC address to the secure server 150 for consideration for inclusion in the SPG. The secure server 150, checks for the uniqueness of the MAC address and public key of the entity in the database 152. Then, based on the group and security policy, the secure server accepts or rejects the request of the requesting entity 130a. The entity 130a is accepted as a member of the secure peer group if it meets the policy conditions. Once the entity's request to be part of the secure peer group is approved, the secure server 150 generates a unique ID for the entity 130a. The unique ID is associated with information regarding the entity 130a, including its MAC address, domain, host name public key information etc. The locked MAC address to identity information, together with the ID, are stored in the database 152 associated with the secure server 150. The unique ID itself is then sent to the entity 130a indicating the entity's acceptance into SPG as a member. The above described process of locking the MAC address to the identity of an entity and making that entity a member of the SPG is continued for all qualified entities within the secure LAN as part of the establishment and configuration of the secure LAN

The operation of configuring the secure LAN at this stage also includes the configuration of the switches 104 and 114 within the secure LAN, or interconnected LANs 103 and 113, for future auto-configuration and monitoring. This may be done manually or via the links 151 a or 151b. The uploading and configuration of qualified entities is also done directly or via links 151a and 151b through switches 104 and 114. Hence, the configuration enabling the locking of a MAC address to the identity of an entity, allows the securing of complex environments in LANs with multiple switches.

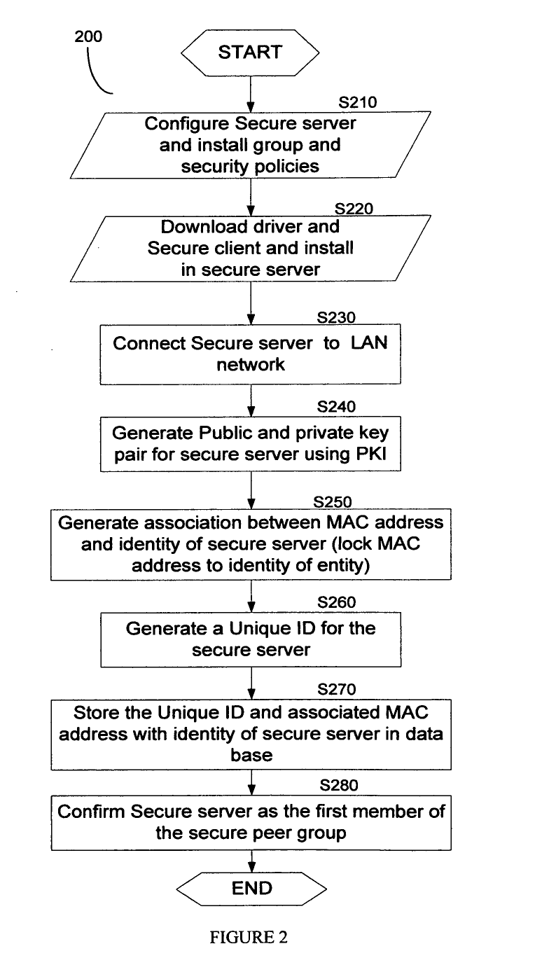

A flowchart of setting up the secure server 150 and configuring its secure client as the first member entity of the peer group is shown in FIG. 2.

Reference is now made to FIG. 2 where an exemplary and non-limiting flowchart 200 shows the configuration of the secure server 150 and its inclusion into the SPG as the first member entity. In S210 the secure server 150 is configured and group and security policies are installed therein. In S220 a driver and security client from a secure location is downloaded and installed in the secure server 150. In S230 the secure server is enabled to connect to the LAN 111. In S240 the secure server operating the security client and driver generates a public and private key-pair. In one embodiment of the disclosed invention the secure server further requests an authentication certificate from a CA for use as part of its identity. In S250 association between the MAC address of the secure server and the identity information generated in S240, comprising at least the public key, is created, locking the MAC address to the identity of the entity. In S260 a unique ID is generated for use by the secure server. In S270 the unique ID generated in S260, and the association between the MAC address and the identity of the secure server 150 created in S250 are stored in the secure data base 152. In S280 the secure server 150 is confirmed as the first entity of the secure peer group on LAN 111.

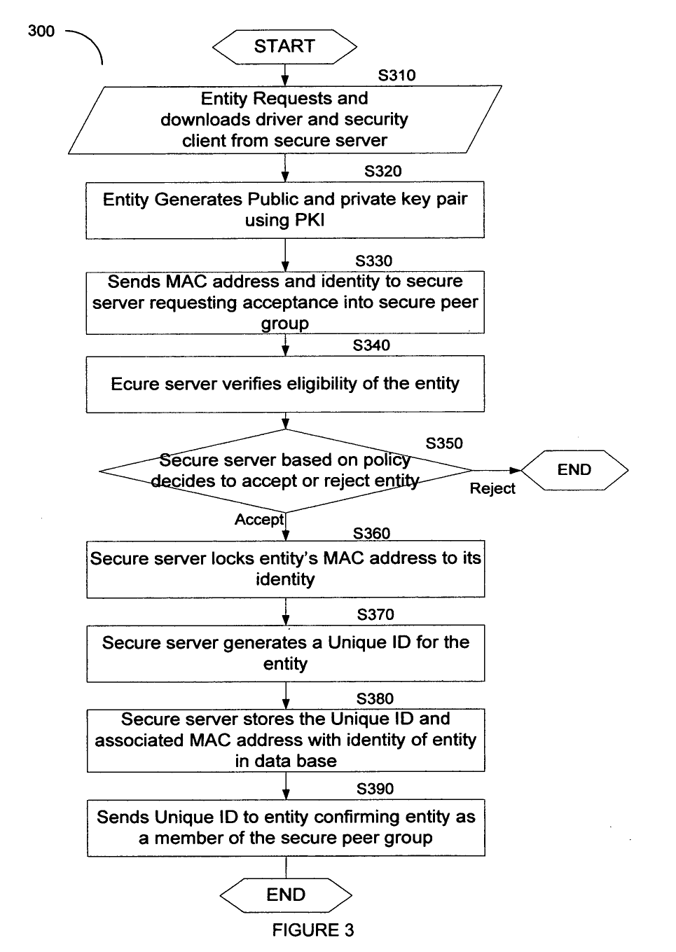

Similarly the addition of qualified entities into the peer group is done using the steps shown in FIG. 3.

FIG. 3 is an exemplary and non-limiting flowchart 300 showing the steps for addition of qualified entities as members of the SPG. In S310, an entity 130a wanting to be a member of SPG downloads and installs a driver and security-client typically from the secure server 150 which has been configured as the first member of the SPG. In S320 the entity 130a generates public—private key pair using PKI. In one embodiment of the disclosed invention the entity further requests an authentication certificate from a CA for use as part of its identity. In S330 the entity 130a sends its MAC address and identity comprising at least its public key, to secure server 150 requesting acceptance into SPG. In S340 the secure server 150 verifies identity of entity 130a. In S350 the secure server 150 checks the entity's eligibility for admission to the SPG based on group and security policies and decides to qualify or reject the entity. In S360 if eligibility of the entity 130a is verified and accepted, the secure server 150 associates and locks the entity's MAC address to the entity's identity. In S370 the secure server 150 prepares a unique ID for the entity 130a. In S380 the secure server stores the entity's ID and the associated MAC address locked to the entity's identity in the data base. In S390 the unique ID generated in S370 for the entity 130a is sent to the entity 130a confirming membership in SPG.

The sequence of steps from 310 to 390 is repeated for each entity that requests to be a member of the SPG.

In the exemplary and non limiting case the pre-verification and pre-authentication of the entities of the SPG is completed only when all the recognized and known qualified entities requesting to be members of SPG are accepted. That is each member entity has downloaded a driver and a security client, has generated security keys using PKI and, optionally, a valid certification from CA. The secure entities have to have their respective Identity and MAC address associated, locked and stored in the database 152 of the secure server 150 and receive a unique ID from the secure server 150. At this point the SPG has been established. The members of the SPG are enabled with the capability to authenticate each other. The pre-authentication and formation of the SPG is a first step towards preventing unauthorized attack entities from connecting into the local area network comprising the secure peers and initiating any sustainable attack based on Layer 2 or higher layers.

In an embodiment of the disclosed invention a security policy may allow associating and locking a single identity to a plurality of MAC addresses, and/or conversely, allow a single MAC address to be associated and locked with a plurality of identities. This may be useful in cases of mirroring systems, failover systems, and others as the case may require.

A typical and exemplary application of the locked MAC to identity of entities is in having a very secure dynamic host configuration protocol process and a secure address resolution protocol process. The details of such secure processes are described and disclosed in the co- filed and pending provisional patent application no. 61/195,098, entitled “Enterprise Security Setup with Prequalified and Authenticated Peer Group Enabled for Secure DHCP and Secure ARP/RARP”, filed on Oct. 3, 2008, assigned to common assignee, and which is incorporated herein by reference for all that it contains.

Even though the above disclosed invention of locking the MAC address of entities to their identities is oriented at providing internal security for the intranet, including LANs, enterprises and metro networks, it is not intended to be limiting by these examples. Furthermore, in some applications of the disclosed invention it will be advantageous to implement a secure network of peers in a hierarchical manner such that a plurality of entities are groups in one SPG and another group of a plurality of network entities in another SPG, the two SPGs being under the hospice of a higher level SPG.

The invention can be adapted to be used with the Internet and other types of network and communication systems to improve the security of communication with the disclosed improvements in security. Such and other applications of the technology disclosed will be recognizable by individuals practicing the art and as such are covered by this disclosure. It should be further understood that the invention may be realized in hardware, software, firmware or any combination thereof. It may be further embodied in a tangible computer readable media, where such media contains a plurality of instructions that when executed on an appropriate hardware, e.g., a microprocessor or a microcontroller, would result in the performance of the methods disclosed hereinabove.

What is claimed is:

1. A method for creating a secure peer group (SPG) comprising:
locking a media access control (MAC) address of a first entity in a network to an identity of said first entity;
registering said first entity as a member of the SPG, the SPG comprising of entities having their respective MAC address locked to an identity; and
preventing a second entity from registering with the SPG using a MAC address already locked to an identity of at least one of the SPG entities;
such that the SPG is enabled to avoid an attack on said network by a network entity attempting to use any one of said MAC address locked to a different identity within the SPG.
